(19) United States
(12) Patent Application Publication
(10) Pub. No.: US 2025/0012898 A1
(43) Pub. Date: Jan. 9, 2025

(54) OPTICAL SENSING SYSTEM AND OPTICAL SENSING METHOD

(71) Applicant: NEC Corporation, Minato-ku, Tokyo (JP)

(72) Inventor: Daisuke TAKEI, Tokyo (JP)

(73) Assignee: NEC Corporation, Minato-ku, Tokyo (JP)

(21) Appl. No.: 18/708,680

(22) PCT Filed: Nov. 24, 2021
(86) PCT No.: PCT/JP2021/042956

§ 371 Date: May 9, 2024

(51) Int. Cl. G01S 7/481; G01S 17/08

(52) U.S. Cl. CPC G01S 7/4817; G01S 7/4818; G01S 17/08

(57) ABSTRACT

The optical sensing system (100) comprises a plurality of scanner devices (1) that are disposed at different sites and a signal processing device (2) that is connected to the plurality of scanner devices (1) by using a plurality of optical fiber cables (3), wherein: the plurality of scanner devices (1) emit laser beams toward a subject and receive reflected light reflected by the subject; and the signal processing device (2) outputs a first optical signal, which corresponds to the laser beams to be emitted by the plurality of scanner devices (1), to the plurality of scanner devices (1) via the plurality of optical fiber cables (3) and acquires a second optical signal, which corresponds to the reflected light received by the plurality of scanner devices (1), from the plurality of scanner devices (1) via the plurality of optical fiber cables (3).

### TECHNICAL FIELD

The present invention relates to an optical sensing system and the like.

### BACKGROUND ART

A system that executes optical sensing based on a principle of light detection and ranging (LiDAR) is known. Further, a type in which, in the system, a scanner unit for LiDAR and a signal processing unit for LiDAR are connected by use of an optical fiber cable is known (e.g., see PTL 1).

PTL 1 discloses an in-vehicle LiDAR system. As illustrated in FIGS. 1A and 1B of PTL 1, the LiDAR system includes a plurality of scanner units (lidar scanners 110A to 110F) and one signal processing unit (centralized laser delivery system 101). Each of the individual scanner units is connected to the signal processing unit by use of an optical fiber cable (optical fiber channels 112A to 112F). A plurality of scanner units, one signal processing unit, and a plurality of optical fiber cables are mounted on one vehicle (vehicle 100).

### CITATION LIST

### Patent Literature

[PTL 1] Japanese Unexamined Patent Application Publication (Translation of PCT Application) No. 2020-504301

### SUMMARY OF INVENTION

### Technical Problem

In a LiDAR system described in PTL 1, one vehicle is mounted with a plurality of scanner units, and the plurality of scanner units scan mutually different spatial ranges (e.g., see paragraphs to of PTL 1). That is to say, one scanner unit only scans a specific spatial range from one direction. Therefore, in the LiDAR system described in PTL 1, regarding an object existing in the specific spatial range, a shape of the object in a range scanned from the one direction can be recognized, but a shape of the object in a range other than the above range may not be recognized. That is to say, a shape of a part being relevant to a back side viewed from one relevant scanner unit among shapes of the object may not be recognized. As a result, there is a problem that it is difficult to recognize an overall shape of the object.

In view of the problem described above, an object of the present invention is to enable recognizing an overall shape of an object to be a subject, in a system of a type in which a signal processing unit and each of individual scanner units are connected by use of an optical fiber cable.

### Solution to Problem

An optical sensing system according to the present invention includes: a plurality of scanner devices that are installed at mutually different sites; and a signal processing device being connected to the plurality of scanner devices by use of a plurality of optical fiber cables, wherein the plurality of scanner devices emit laser beams toward a subject, and receive reflected light reflected by the subject, and the signal processing device outputs, to the plurality of scanner devices via the plurality of optical fiber cables, a first optical signal being relevant to the laser beam to be emitted by each of the plurality of scanner devices, and acquires, from the plurality of scanner devices via the plurality of optical fiber cables, a second optical signal being relevant to the reflected light received by each of the plurality of scanner devices.

An optical sensing method according to the present invention includes: by a plurality of scanner devices that are installed at mutually different sites, emitting laser beams toward a subject, and receiving reflected light reflected by the subject; and, by a signal processing device being connected to the plurality of scanner devices by use of a plurality of optical fiber cables, outputting, to the plurality of scanner devices via the plurality of optical fiber cables, a first optical signal being relevant to the laser beam to be emitted by each of the plurality of scanner devices, and acquiring, from the plurality of scanner devices via the plurality of optical fiber cables, a second optical signal being relevant to the reflected light received by each of the plurality of scanner devices.

### Advantageous Effects of Invention

The present invention enables recognizing an overall shape of an object to be a subject, in a system of a type in which a signal processing unit and each of individual scanner units are connected by use of an optical fiber cable.

### BRIEF DESCRIPTION OF DRAWINGS

FIG. 1 is a block diagram illustrating an optical sensing system according to a first example embodiment.

FIG. 2 is a block diagram illustrating each of individual scanner devices in the optical sensing system according to the first example embodiment.

FIG. 3 is a block diagram illustrating a hardware configuration of each of the individual scanner devices in the optical sensing system according to the first example embodiment.

FIG. 4 is a block diagram illustrating a signal processing device in the optical sensing system according to the first example embodiment.

FIG. 5 is a block diagram illustrating the signal processing unit of the signal processing device in the optical sensing system according to the first example embodiment.

FIG. 6 is a block diagram illustrating a hardware configuration of the signal processing device in the optical sensing system according to the first example embodiment.

FIG. 7 is a block diagram illustrating another hardware configuration of the signal processing device in the optical sensing system according to the first example embodiment.

FIG. 8 is a block diagram illustrating another hardware configuration of the signal processing device in the optical sensing system according to the first example embodiment.

FIG. 9 is a flowchart illustrating an operation of the signal processing device in the optical sensing system according to the first example embodiment.

FIG. 10 is a flowchart illustrating the operation of the signal processing unit of the signal processing device in the optical sensing system according to the first example embodiment.

FIG. 11 is an explanatory diagram illustrating a specific example of the optical sensing system according to the first example embodiment.

FIG. 12 is an explanatory diagram illustrating a specific example of an optical sensing system for comparison with the optical sensing system according to the first example embodiment.

FIG. 13 is an explanatory diagram illustrating a modified example of the optical sensing system according to the first example embodiment.

### EXAMPLE EMBODIMENT

Example embodiments of the present invention are described in detail below with reference to the accompanying drawings.

### First Example Embodiment

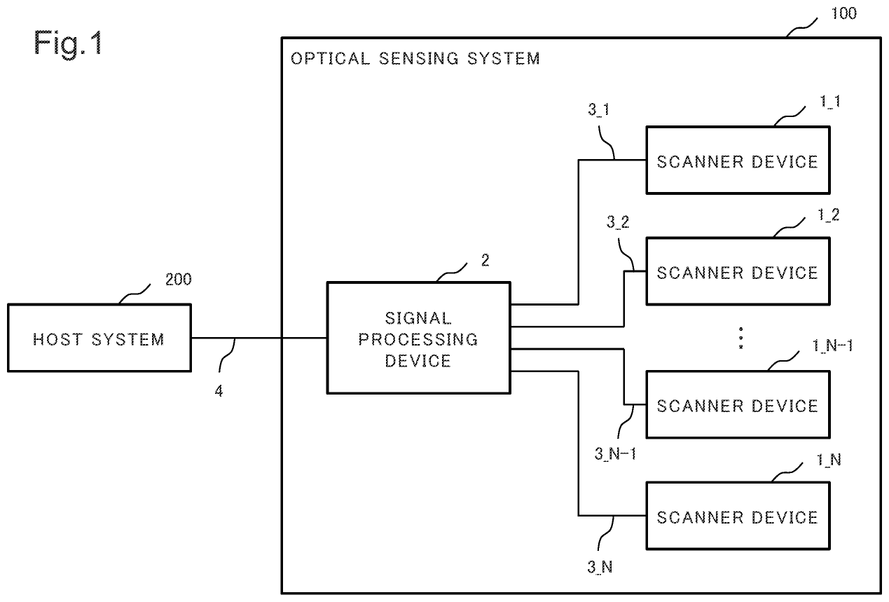

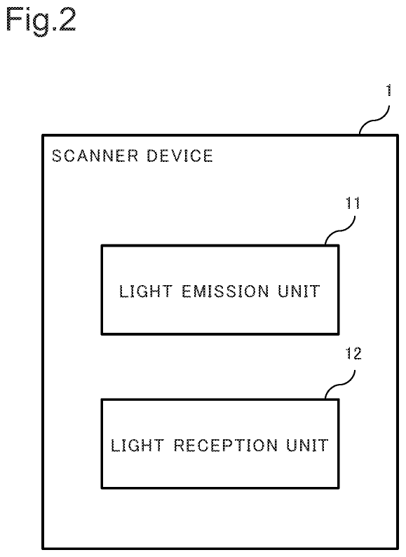

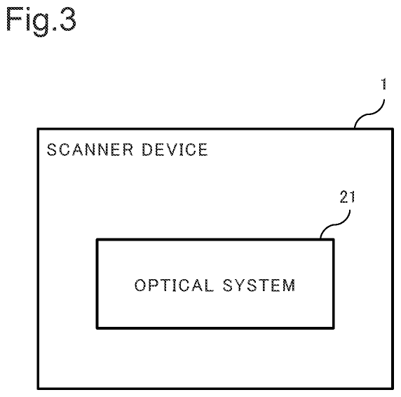

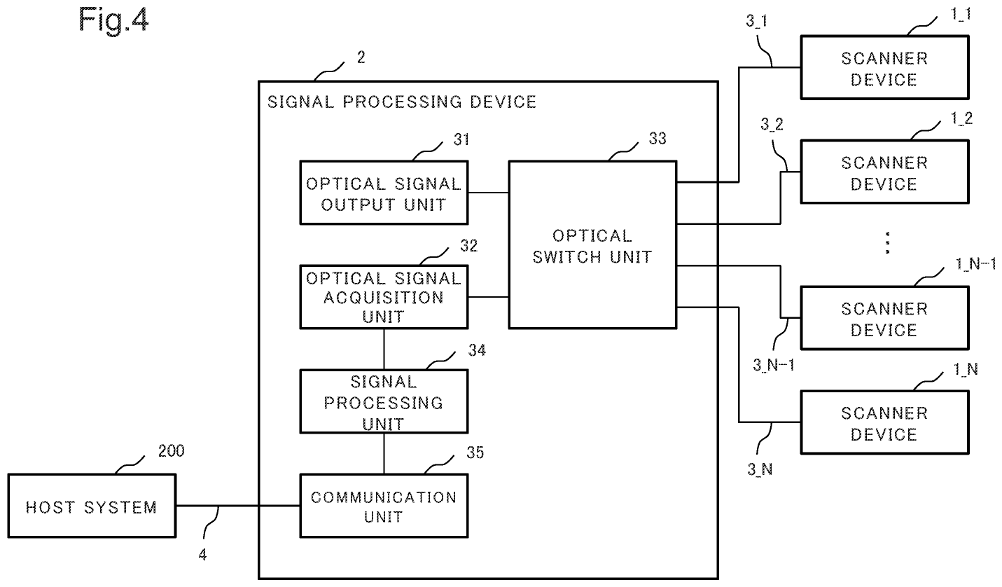

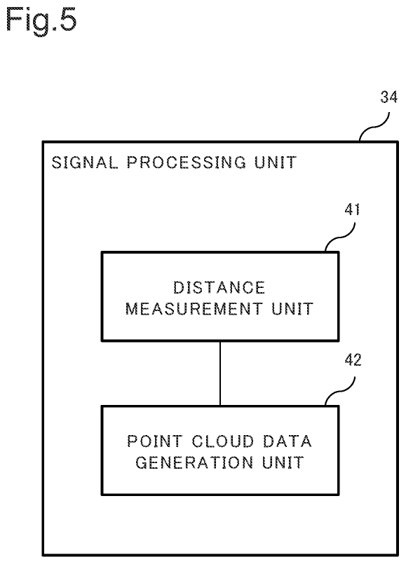

FIG. 1 is a block diagram illustrating an optical sensing system according to the first example embodiment. FIG. 2 is a block diagram illustrating each of individual scanner devices in the optical sensing system according to the first example embodiment. FIG. 3 is a block diagram illustrating a hardware configuration of each of the individual scanner device in the optical sensing system according to the first example embodiment. FIG. 4 is a block diagram illustrating a signal processing device in the optical sensing system according to the first example embodiment. FIG. 5 is a block diagram illustrating the signal processing unit of the signal processing device in the optical sensing system according to the first example embodiment. The optical sensing system according to the first example embodiment is described with reference to FIGS. 1 to 5.

As illustrated in FIG. 1, an optical sensing system 100 includes a plurality of scanner devices 1 and one signal processing device 2. The plurality of scanner devices 1 are connected to a signal processing device 2 by use of a plurality of optical fiber cables 3. In the example illustrated in FIG. 1, the optical sensing system 100 includes N scanner devices 1_1 to 1_N. Each of the scanner devices 1_1 to 1_N is connected to the signal processing device 2 by use of one relevant optical fiber cable 3 among N optical fiber cables 3_1 to 3_N. That is to say, in the example illustrated in FIG. 1, the optical fiber cables 3_1 to 3_N and the scanner devices 1_1 to 1_N are relevant one to one. Herein, N is any integer equal to or more than 2. However, as described later, such a relevance relationship is not limited to one-to-one.

Each of the individual scanner devices 1 is installed in a space (hereinafter may be referred to as a “subject space”) including an object (hereinafter may be referred to as a “subject object”) to be a subject of sensing by the optical sensing system 100. Further, each of the individual scanner devices 1 is installed toward a subject. Herein, the plurality of scanner devices 1 are installed independently of each other. That is to say, the plurality of scanner devices 1 are installed at mutually different sites in the subject space. Thereby, the plurality of scanner devices 1 are directed to the subject from mutually different positions. In other words, the plurality of scanner devices 1 are directed to the subject from mutually different directions.

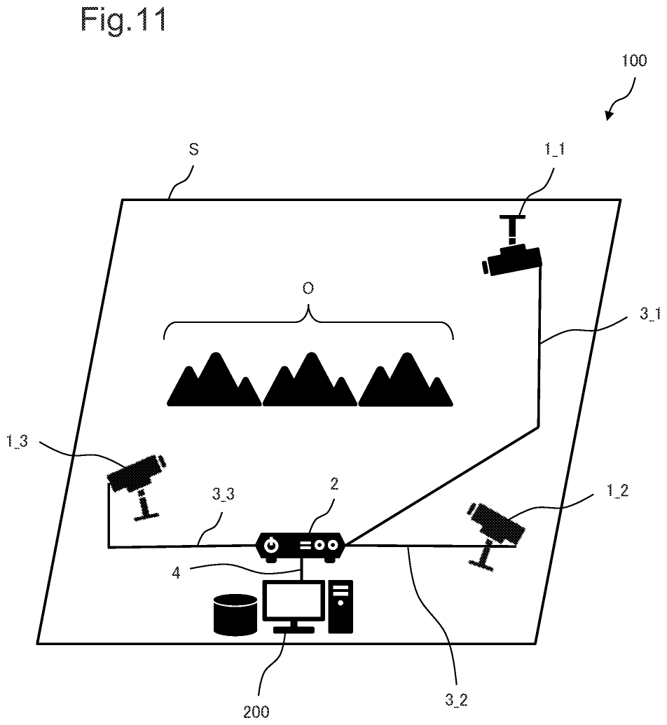

More specifically, the plurality of scanner devices 1 are disposed around the subject. That is to say, the plurality of scanner devices 1 are disposed in such a way as to surround the subject. For example, the one relevant scanner device 1 among the N scanner devices 1 is disposed at a position being relevant to each vertex of an N-sided area including the subject. Thereby, as described later with reference to FIG. 11, a laser beam for sensing is applied to the overall or substantially overall subject. Hereinafter, being overall or substantially overall may be simply referred to as “overall”.

A subject is, for example, a plurality of raw materials heaps in a raw material yard. In this case, the raw material yard is a subject space. A plurality of raw materials heaps are usually arranged in a row or in a plurality of rows in a raw material yard. Further, an area of a raw material yard is usually several ten meters to several hundred meters square. That is to say, an area of a subject space is, for example, several ten meters to several hundred meters square.

Specifically, for example, a plurality of kinds of raw materials for iron making are kept in a raw material yard for iron making. In this instance, in the raw material yard for iron making, a plurality of scanner devices 1 are disposed in such a way as to surround the raw materials heap.

As illustrated in FIG. 1, the signal processing device 2 is connected to a host system 200 by use of an electric communication line 4.

Thereby, the signal processing device 2 freely communicates with the host system 200. The host system 200 is a host system for the optical sensing system 100. The host system 200 is provided outside the optical sensing system 100. The electric communication line 4 is constituted of, for example, a cable for electric communication. Specifically, for example, the electric communication line 4 is constituted of a local area network (LAN) cable.

As illustrated in FIG. 2, each of the individual scanner devices 1 includes a light emission unit 11 and a light reception unit 12. The light emission unit 11 emits a laser beam for sensing toward a subject. The emitted laser beam is applied to the subject. Herein, in each of the individual scanner devices 1, an emission direction of a laser beam by the light emission unit 11 is variable. The light emission unit 11 sequentially emits a laser beam in a plurality of directions. Thereby, a laser beam is applied in such a way as to scan the subject. The applied laser beam is reflected by the subject. A backscattered component of the reflected light (hereinafter may be referred to as “reflected light”) is received by the light reception unit 12. Hereinafter, the light received by the light reception unit 12 of the reflected light may be referred to as “received light”.

Herein, each of the individual scanner devices 1 does not have a function of generating a laser beam. Further, each of the individual scanner devices 1 does not have a function of converting received light into an electric signal. As described later with reference to FIG. 4, the functions are provided in the signal processing device 2.

That is to say, as illustrated in FIG. 3, each of the individual scanner devices 1 includes an optical system 21 being relevant to the light emission unit 11 and the light reception unit 12. In other words, functions of the light emission unit 11 and the light reception unit 12 are achieved by the optical system 21. Note that, the optical system 21 may include a first optical system (not illustrated) being relevant to the light emission unit 11 and a second optical system (not illustrated) being relevant to the light reception unit 12.

As described later with reference to FIG. 4, the signal processing device 2 generates an optical signal (hereinafter may be referred to as a “first optical signal”) constituted of a laser beam, and outputs the generated first optical signals to each of the individual optical fiber cables 3. The output first optical signal propagates through the optical fiber cable 3, and is input to the relevant scanner device 1. The optical system 21 emits the input first optical signal (i.e. laser beam) as a laser beam for sensing. In this way, a function of the light emission unit 11 is achieved.

Further, the optical system 21 of each of the individual scanner devices 1 receives reflected light, and outputs the received reflected light (i.e., received light) to the relevant optical fiber cable 3. In this way, a function of the light reception unit 12 is achieved. The output received light propagates through the optical fiber cable 3 as an optical signal (hereinafter may be referred to as a “second optical signal”), and is input to the signal processing device 2. As described later with reference to FIG. 4, the input second optical signal is converted into an electric signal in the signal processing device 2.

As illustrated in FIG. 4, the signal processing device 2 includes an optical signal output unit 31, an optical signal acquisition unit 32, an optical switch unit 33, a signal processing unit 34, and a communication unit 35. The optical switch unit 33 is provided between the optical signal output unit 31 and the optical signal acquisition unit 32, and the plurality of optical fiber cables 3.

The optical signal output unit 31 generates a first optical signal, and outputs the generated first optical signal. As described above, the first optical signal is constituted of a laser beam. The output first optical signal is output to each of the individual optical fiber cables 3 via the optical switch unit 33. The optical signal output unit 31 is constituted of, for example, an optical transmitter for LiDAR.

On the other hand, the second optical signal input to the signal processing device 2 via each of the individual optical fiber cables 3 is input to the optical signal acquisition unit 32 via the optical switch unit 33.

The optical signal acquisition unit 32 acquires the second optical signal, and converts the acquired second optical signal into an electric signal. The optical signal acquisition unit 32 is constituted of, for example, an optical receiver for LiDAR.

The optical switch unit 33 is a switch for switching an output destination of the first optical signal and an acquisition source of the second optical signal. The optical switch unit 33 is constituted of one or more optical switches.

For example, it is assumed that the three scanner devices 1_1 to 1_3 are connected to the signal processing device 2 by use of the optical fiber cables 3_1 to 3_3 respectively. In this case, the optical switch unit 33 freely switches between a first connection state, a second connection state, and a third connection state below. That is to say, the first connection state is a state in which the optical signal output unit 31 and the optical signal acquisition unit 32 are optically connected to the first optical fiber cable 3_1. The second connection state is a state in which the optical signal output unit 31 and the optical signal acquisition unit 32 are optically connected to the second optical fiber cable 3_2. The third connection state is a state in which the optical signal output unit 31 and the optical signal acquisition unit 32 are optically connected to the third optical fiber cable 3_3.

In the first connection state, the first optical signal output by the optical signal output unit 31 is input to the first scanner device 1_1 via the optical switch unit 33 and the first optical fiber cable 3_1. Further, the second optical signal output by the first scanner device 1_1 is input to the optical signal acquisition unit 32 via the first optical fiber cable 3_1 and the optical switch unit 33.

In the second connection state, the first optical signal output by the optical signal output unit 31 is input to the second scanner device 1_2 via the optical switch unit 33 and the second optical fiber cable 3_2. Further, the second optical signal output by the second scanner device 1_2 is input to the optical signal acquisition unit 32 via the second optical fiber cable 3_2 and the optical switch unit 33.

In the third connection state, the first optical signal output by the optical signal output unit 31 is input to the third scanner device 1_3 via the optical switch unit 33 and the third optical fiber cable 3_3. Further, the second optical signal output by the third scanner device 1_3 is input to the optical signal acquisition unit 32 via the third optical fiber cable 3_3 and the optical switch unit 33.

In this way, the first optical signal is output to each of the scanner devices 1_1 to 1_3. In other words, a plurality of first optical signals are output to the plurality of scanner devices 1, respectively. Further, the second optical signal is acquired from each of the scanner devices 1_1 to 1_3. In other words, a plurality of second optical signals are acquired from the plurality of scanner devices 1, respectively.

The optical switch unit 33 sequentially switches between the first connection state, the second connection state, and the third connection state. Thereby, emission of a laser beam for sensing and reception of the relevant reflected light are sequentially executed by the first scanner device 1_1, the second scanner device 1_2, and the third scanner device 1_3. The optical signal acquisition unit 32 sequentially acquires second optical signals being relevant to the pieces of received light, and sequentially converts the second optical signals into electric signals. The optical signal acquisition unit 32 outputs the converted electric signal to the signal processing unit 34.

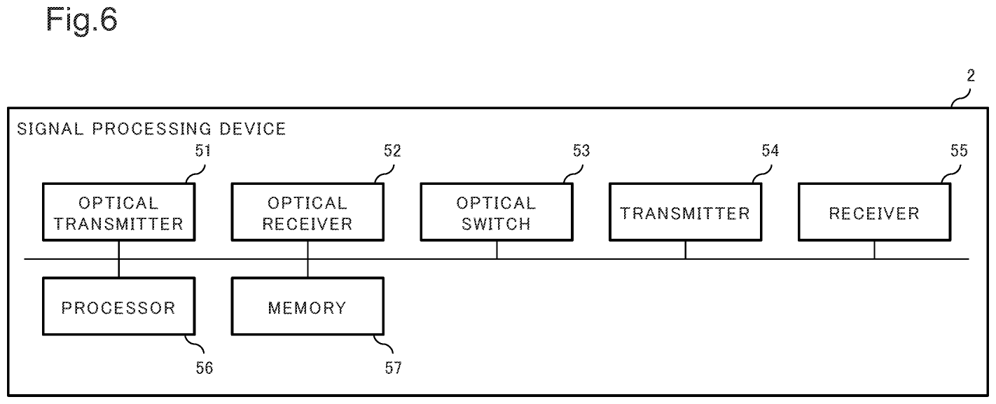

The signal processing unit 34 executes predetermined signal processing by use of the electric signal output by the optical signal acquisition unit 32. The signal processing executed by the signal processing unit 34 includes, for example, measurement of a distance D based on a principle of LiDAR, and generation of point cloud data based on the measured distance D. In this case, as illustrated in FIG. 6, the signal processing unit 34 includes a distance measurement unit 41 and a point cloud data generation unit 42.

The distance measurement unit 41 executes measurement of the distance D based on the principle of LiDAR. The measurement uses, for example, a time of flight (ToF) method or a frequency modulated continuous wave (FMCW) method.

### (When ToF is Used)

When ToF is used, the optical signal output unit 31 outputs a pulsed first optical signal. Each of individual pulses (i.e. each of the individual first optical signals) is relevant to a laser beam emitted by each of the individual scanner devices 1 in each direction. In other words, switching of connection in the optical switch unit 33 and changing of an emission direction of a laser beam in each of the individual scanner devices 1 are set in such a way as to achieve such a relevance relationship.

The distance measurement unit 41 acquires information indicating a timing T1′ at which the optical signal output unit 31 outputs the first optical signal. Such information is acquired from, for example, the optical signal output unit 31. Further, the distance measurement unit 41 detects, by use of the electric signal output by the optical signal acquisition unit 32, a timing T2′ at which the optical signal acquisition unit 32 acquires a second optical signal being relevant to the output first optical signal. Specifically, for example, the distance measurement unit 41 compares amplitude in a time waveform of the output electric signal with a predetermined threshold value, detects a timing at which such amplitude exceeds the threshold value, and thereby determines the timing T2″.

Herein, the time difference ΔT′ between the timings T1′ and T2′ is equivalent to a time difference ΔT between a timing T1 at which a laser beam for sensing being relevant to the output first optical signal is emitted and a timing T2 at which the reflected light being relevant to the input second optical signal is received. In other words, the time difference ΔT′ is equivalent to a round-trip propagation time of the pieces of light (i.e. the relevant laser beam for sensing and the relevant reflected light). Accordingly, the distance measurement unit 41 calculates a one-way propagation distance (i.e. the distance D) being relevant to such a round-trip propagation time, by use of a predetermined mathematical formula related to ToF. In this way, the distance D is measured.

### (When FMCW is Used)

When FMCW is used, the optical signal output unit 31 outputs a chirp-shaped first optical signal by executing predetermined frequency modulation processing for FMCW. Thereby, the laser beam emitted in each direction by each of the individual scanner devices 1 also becomes chirp-shaped. Further, the optical signal acquisition unit 32 executes coherent detection for a second optical signal (i.e., received light). Thereby, an electric signal output by the optical signal acquisition unit 32 includes a frequency and a phase in the relevant second optical signal (i.e. received light).

The distance measurement unit 41 acquires information indicating a frequency of the first optical signal. Such information is acquired from, for example, the optical signal output unit 31. Further, the distance measurement unit 41 detects a frequency of a relevant second optical signal, by use of the electric signal output by the optical signal acquisition unit 32. The distance measurement unit 41 calculates a difference value (so-called “beat frequency”) between the frequencies. The distance measurement unit 41 calculates the distance D, based on the calculated beat frequency, by use of a predetermined mathematical formula related to FMCW. In this way, the distance D is measured.

Note that, a measuring method of the distance D is not limited to the specific examples. Various known techniques can be used for measurement of the distance D. Detailed description of the techniques is omitted. For example, the distance measurement unit 41 may calculate the distance D, based on a phase difference between the first optical signal and the relevant second optical signal (i.e. a phase difference between a laser beam for sensing and relevant received light) (so-called “indirect ToF”).

The distance measurement unit 41 generates information (hereinafter may be referred to as “distance information”) indicating the distance D measured in this way. The distance measurement unit 41 outputs the generated distance information to the point cloud data generation unit 42. Herein, the distance information is output in association with information (hereinafter may be referred to as “emission position information”) indicating an installation position of the scanner device 1 that has emitted a laser beam being relevant to each of the individual distances D. Further, the distance information is output in association with information (hereinafter may be referred to as “emission direction information”) indicating an emission direction of a laser beam being relevant to each of the individual distances D. Association thereof is achieved, for example, as follows.

That is to say, after each of the individual scanner devices 1 is installed and before use of the optical sensing system 100 is started, a person (e.g. a user of the optical sensing system 100) inputs, to the signal processing device 2, information indicating an installation position and an installation direction of each of the individual scanner devices 1.

Further, in the optical sensing system 100, an order in which the plurality of scanner devices 1 emit laser beams and an order in which each of the individual scanner devices 1 emits a laser beam in a plurality of directions are previously set. Information indicating the orders is stored in the signal processing device 2. Note that, a timing at which the optical signal output unit 31 outputs a first optical signal, a timing and an order in which the optical switch unit 33 switches a connection state, and changing of an emission direction of a laser beam in each of the individual scanner devices 1 are controlled in such a way that the orders are achieved.

By using the pieces of information, it is determined which direction a laser beam being relevant to each of the individual distances D is emitted and which position the scanner device 1 emitting the laser beam is in. In this way, association of distance information with emission position information and emission direction information is achieved. Such association is executed by the signal processing device 2 (e.g. the distance measurement unit 41).

The point cloud data generation unit 42 generates point cloud data by use of the distance information output by the distance measurement unit 41, and the emission position information and the emission direction information associated with the distance information. That is to say, the point cloud data generation unit 42 calculates, by use of the pieces of information, a position of a site (hereinafter referred to as a “reflection point”) where a laser beam being relevant to each of the individual distances D is reflected. Thereby, data indicating point clouds being relevant to positions of the reflection points, i.e. point cloud data are generated.

Herein, as described above, distance information includes the distance D being relevant to a laser beam emitted by each of the plurality of scanner devices 1. A point cloud in point cloud data generated by the point cloud data generation unit 42 indicates a position of a reflection point being relevant to each of the plurality of scanner devices 1. That is to say, generation of point cloud data by the point cloud data generation unit 42 is through a so-called “point cloud synthesis”. In other words, the point cloud data generation unit 42 generates point cloud data by executing point cloud synthesis regarding the plurality of scanner devices 1.

Note that, by applying a laser beam for sensing to another object (e.g. ground around a subject) different from the subject, a point cloud being relevant to the another object can be included in point cloud data in addition to a point cloud being relevant to the subject. In such a case, the point cloud data generation unit 42 may extract a point cloud being relevant to the subject from among the point clouds, by grouping point clouds, based on a point-to-point distance, a result of plane detection, or the like. Thereby, the point cloud data generation unit 42 may exclude, from the point cloud data, a point cloud being relevant to the another subject.

The communication unit 35 (see FIG. 4) transmits, to outside, information (hereinafter may be referred to as “result information”) indicating a result of signal processing by the signal processing unit 34. More specifically, the communication unit 35 transmits the result information to the host system 200. The electric communication line 4 is used for transmission of the result information.

In this way, the optical sensing system 100 is constituted. That is to say, the optical sensing system 100 is a system that executes optical sensing based on the principle of LiDAR.

The result information can be used by the host system 200 for various applications. Specifically, for example, the host system 200 generates a three-dimensional model of the subject by use of the point cloud data included in the result information. The host system 200 estimates a volume of the subject (e.g. a raw materials heap) by use of the generated three-dimensional model. Alternatively, for example, the host system 200 detects occurrence of an abnormality (e.g. a state in which a raw materials heap is collapsing) in a subject, based on a shape of the generated three-dimensional model.

Herein, the host system 200 may generate the following image, and display the generated image on a non-illustrated display device (e.g. a display). Specifically, for example, the host system 200 generates, by use of the point cloud data included in the result information, an image (hereinafter may be referred to as a “point cloud image”) formed by disposing, in a virtual three-dimensional space, a point cloud included in the point cloud data. Alternatively, for example, the host system 200 generates a three-dimensional model as described above, and generates an image (hereinafter may be referred to as a “three-dimensional model image”) including the generated three-dimensional model. The point cloud image or the three-dimensional model image is displayed on the display, and thereby, a person (e.g. a user of the host system 200) can easily recognize a shape of the subject visually.

Next, a hardware configuration of the signal processing device 2 is described with reference to FIGS. 6 to 8.

As illustrated in each of FIGS. 6 to 8, the signal processing device 2 includes an optical transmitter 51, an optical receiver 52, an optical switch 53, a transmitter 54, and a receiver 55. A function of the optical signal output unit 31 is achieved by the optical transmitter 51. A function of the optical signal acquisition unit 32 is achieved by the optical receiver 52. A function of the optical switch unit 33 is achieved by the optical switch 53. A function of the communication unit 35 is achieved by the transmitter 54 and the receiver 55.

Further, as illustrated in FIG. 6, the signal processing device 2 includes a processor 56 and a memory 57. In this case, the memory 57 stores a program being relevant to a function of the signal processing unit 34. The processor 56 reads and executes a program stored in the memory 57. Thereby, the function of the signal processing unit 34 is achieved.

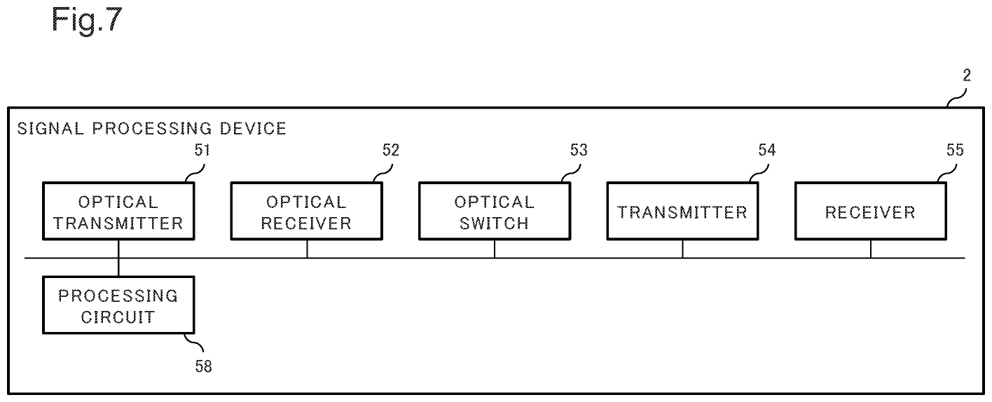

Alternatively, as illustrated in FIG. 7, the signal processing device 2 includes a processing circuit 58. In this case, the processing circuit 58 executes processing being relevant to the function of the signal processing unit 34. Thereby, the function of the signal processing unit 34 is achieved.

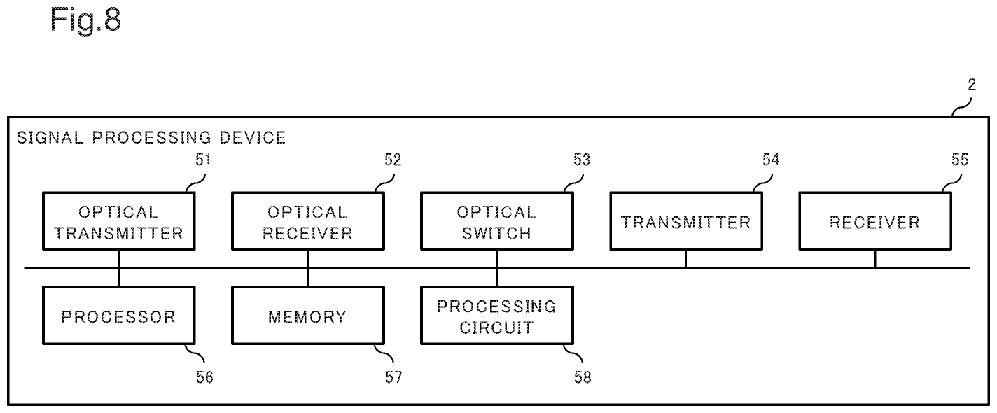

Alternatively, as illustrated in FIG. 8, the signal processing device 2 includes a processor 56, a memory 57, and a processing circuit 58. In this case, some of the functions of the signal processing unit 34 are achieved by the processor 56 and the memory 57, and rest of the functions of the signal processing unit 34 are achieved by the processing circuit 58.

The processor 56 is constituted of one or more processors. Each of the individual processors uses, for example, a central processing unit (CPU), a graphics processing unit (GPU), a microprocessor, a microcontroller, or a digital signal processor (DSP).

The memory 57 is constituted of one or more memories. Each of the individual memories uses a volatile memory or a non-volatile memory. That is to say, each of the individual memories is, for example, a random access memory (RAM), a read only memory (ROM), a flash memory, an erasable programmable read only memory (EPROM), an electrically erasable programmable read only memory (EEPROM), a solid state drive, a hard disk drive, a flexible disc, a compact disc, a digital versatile disc (DVD), a Blu-ray disc, a magneto optical (MO) disc, or a mini disc.

The processing circuit 58 is constituted of one or more processing circuits. Each of the individual processing circuits uses, for example, an application specific integrated circuit (ASIC), a programmable logic device (PLD), a field programmable gate array (FPGA), a system on a chip (SoC), or a system large scale integration (LSI).

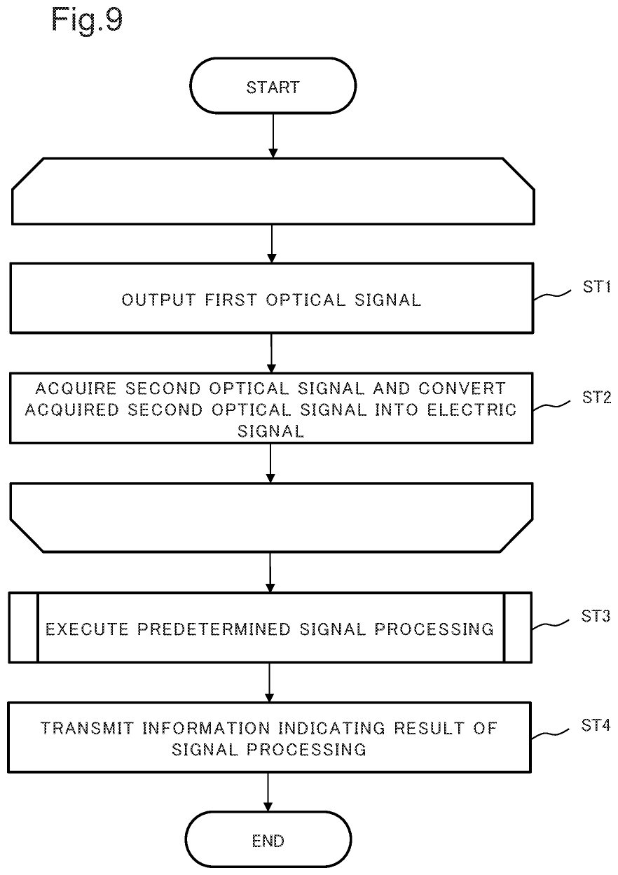

Next, an operation of the optical sensing system 100 is described. More specifically, an operation of the signal processing device 2 is described with reference to a flowchart illustrated in FIG. 9.

First, the optical signal output unit 31 outputs a first optical signal (step ST1). Subsequently, the optical signal acquisition unit 32 acquires a relevant second optical signal, and converts the acquired second optical signal into an electric signal (step ST2). The pieces of processing are repeatedly executed, for example, until all the scanner devices 1 included in the optical sensing system 100 emit laser beams for sensing in all previously set directions. In the flowchart illustrated in FIG. 9, illustration of a condition of the repetition is omitted.

Subsequently, the signal processing unit 34 executes predetermined signal processing by use of the converted electric signal (step ST3). A specific example of signal processing executed by the signal processing unit 34 is as already described. Thus, detailed description is omitted.

Subsequently, the communication unit 35 transmits, to outside, information indicating a result of the signal processing in step ST3 (i.e., result information) (step ST4). More specifically, the communication unit 35 transmits the result information to the host system 200 by use of the electric communication line 4.

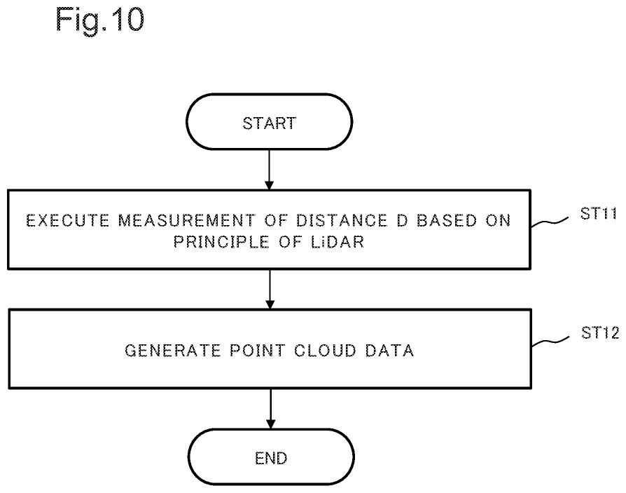

Next, an operation of the signal processing unit 34 is described with reference to a flowchart illustrated in FIG. 10. That is to say, a specific example of signal processing executed in step ST3 is described.

First, the distance measurement unit 41 executes measurement of the distance D based on the principle of LiDAR (step ST11). Thereby, distance information is generated. A specific example of such a measuring method is as already described. Thus, detailed description is omitted.

Subsequently, the point cloud data generation unit 42 generates point cloud data by use of distance information generated in step ST11 and associated emission position information and emission direction information (step ST12). That is to say, the point cloud data generation unit 42 generates point cloud data by executing point cloud synthesis. In this case, result information transmitted in step ST4 is information including the generated point cloud data

Next, a specific example of the optical sensing system 100 is described with reference to FIG. 11.

In the figure, O indicates a subject. As described above, the subject is, for example, a plurality of raw materials heaps in a raw material yard. In the example illustrated in FIG. 11, three raw materials heaps are disposed in a line. A subject space (“S” in the figure) in this case is the raw material yard.

In the example illustrated in FIG. 11, the optical sensing system 100 includes three scanner devices 1_1 to 1_3. Each of the scanner devices 1_1 to 1_3 is connected to the signal processing device 2 by use of the one relevant optical fiber cable 3 among the three optical fiber cables 3_1 to 3_3. As described above, the scanner devices 1_1 to 1_3 are installed in the subject space. In addition to this, in the example illustrated in FIG. 11, the signal processing device 2 is also installed in the subject space. Further, the host system 200 is also installed in the subject space.

Each of the scanner devices 1_1 to 1_3 is installed toward a subject. Herein, the scanner devices 1_1 to 1_3 are installed independently of each other. That is to say, the scanner devices 1_1 to 1_3 are installed at mutually different sites in the subject space. More specifically, the scanner devices 1_1 to 1_3 are disposed around the subject. That is to say, the scanner devices 1_1 to 1_3 are disposed in such a way as to surround the subject. In the example illustrated in FIG. 11, the scanner devices 1_1 to 1_3 are each disposed at a position being relevant to each vertex in a triangular region (not illustrated) including the subject. Thereby, a laser beam for sensing is applied to the overall subject.

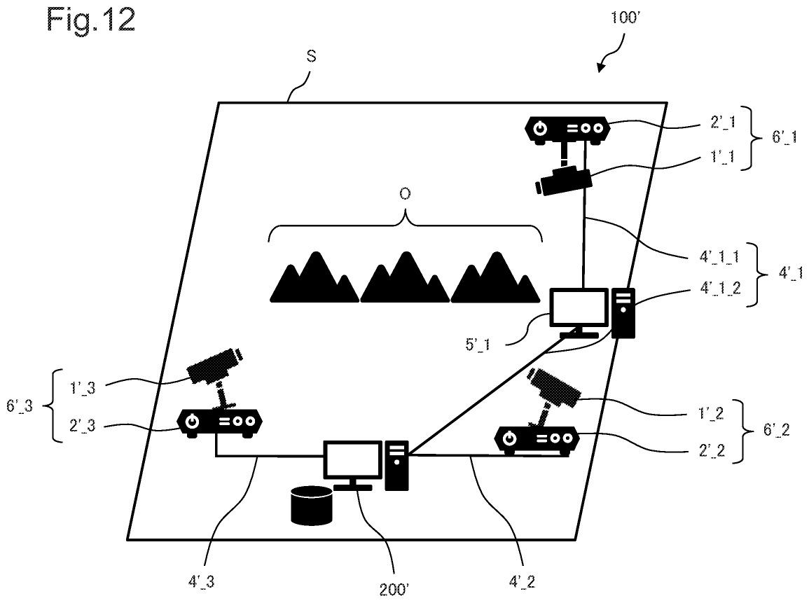

Next, an optical sensing system 100′ for comparison with the optical sensing system 100 is described with reference to FIG. 12. Note that, in FIG. 12, description thereof is omitted by assigning the same reference sign to an element similar to that illustrated in FIG. 11.

As illustrated in FIG. 12, the optical sensing system 100′ includes a plurality of optical sensing devices 6′. Each of individual optical sensing devices 6′ is constituted of a LiDAR device. That is to say, each of the individual optical sensing devices 6′ includes a scanner unit 1′ and a signal processing unit 2′. The scanner unit 1′ is relevant to the scanner device 1 in the optical sensing system 100. The signal processing unit 2′ is relevant to the signal processing device 2 in the optical sensing system 100.

The scanner unit 1′ emits a laser beam for sensing toward a subject, and receives the relevant reflected light. However, the scanner unit 1′ has a function of generating a laser beam for sensing, and a function of converting received light into an electric signal. That is to say, the scanner unit 1′ is constituted of, for example, an optical transmitter for LiDAR, an optical receiver, and an optical system.

The signal processing unit 2′ executes measurement of the distance D based on the principle of LiDAR. Thereby, distance information is generated. In addition to this, the signal processing unit 2′ may generate point cloud data by use of the generated distance information. Thereby, point cloud data indicating a point cloud acquired by each of the individual optical sensing devices 6′ are generated.

Each of the individual signal processing unit 2′ is connected to a host system 200′ by use of an electric communication line 4′. Thereby, each of the individual signal processing units 2′ freely communicates with the host system 200′. That is to say, the electric communication line 4′ is relevant to the electric communication line 4 in the optical sensing system 100. Each of the individual signal processing units 2′ transmits the generated point cloud data to the host system 200″. The host system 200′ generates a three-dimensional model of the subject, by synthesizing the point cloud data (i.e. by executing point cloud synthesis).

Each of the individual electric communication lines 4′ is constituted of a cable for electric communication. Specifically, for example, each of the individual electric communication lines 4′ is constituted of a LAN cable. Usually, a distance in which a signal is transmittable by use of one wired electric communication line is short compared to a distance in which a signal is transmittable by use of one optical fiber cable. Thus, especially when an area of a subject space is large, transmission of the signal may become difficult due to prolongation of a length of one wired electric communication line. Accordingly, a repeater 5′ for amplifying such a signal is installed.

In the example illustrated in FIG. 12, the optical sensing system 100′ includes three optical sensing devices 6′_1 to 6′_3. The optical sensing devices 6′_1 to 6′_3 include scanner units 1′_1 to 1′_3, respectively. Further, the optical sensing devices 6′_1 to 6′_3 include signal processing units 2′_1 to 2′_3, respectively. The signal processing units 2′_1 to 2′_3 are connected to the host system 200′ by use of the one relevant electric communication line 4′ among the three electric communication lines 4′_1 to 4′_3. However, a repeater 5′_1 for amplification is provided in a middle of the electric communication line 4′_1. Thereby, the one electric communication line 4′_1 is divided into two electric communication lines 4′_1_1 and 4′_1_2.

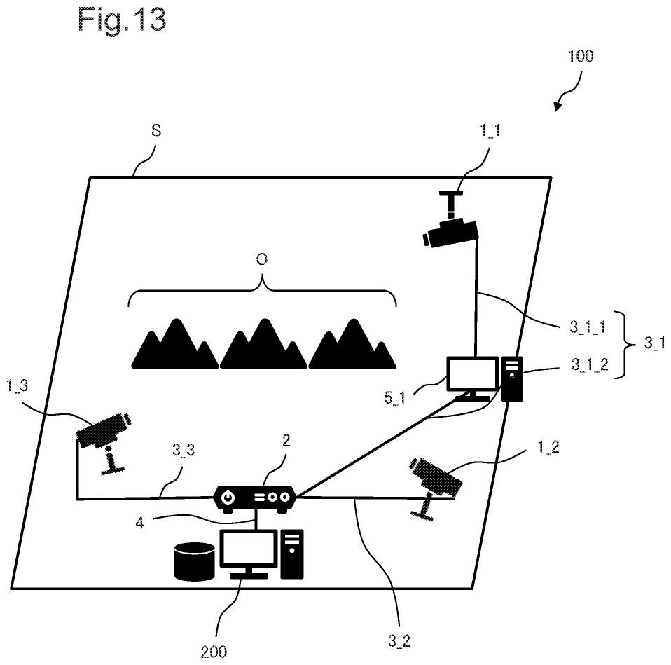

Next, a modified example of the optical sensing system 100 is described with reference to FIG. 13.

Usually, a distance in which a signal is transmittable by use of one optical fiber cable is long compared to a distance in which a signal is transmittable by use of one wired electric communication line. Especially, a distance in which a signal is transmittable by use of one optical fiber cable is sufficiently long relative to the area of the subject space. Thus, in principle, an optical repeater being relevant to the repeater 5′ is not needed in the optical sensing system 100.

However, depending on a laying aspect of each of the individual optical fiber cables 3, a laying length of each of the individual optical fiber cables 3 may become long beyond a distance in which the signal is transmittable. For example, a laying length of the optical fiber cable 3 may become long by providing the optical fiber cable 3 in such a way as to meander, or providing the optical fiber cable 3 in such a way as to greatly detour an obstacle. In such a case, the optical sensing system 100 may exceptionally include an optical repeater 5 being relevant to the repeater 5′. That is to say, the optical repeater 5 is provided in a middle of at least the one optical fiber cable 3 among the plurality of optical fiber cables 3. The optical repeater 5 is constituted of, for example, an optical amplifier.

In the example illustrated in FIG. 13, an optical repeater 5_1 for amplification is provided in a middle of the optical fiber cable 3_1. Thereby, the one optical fiber cable 3_1 is divided into two optical fiber cables 3_1_1 and 3_1_2.

Next, another modified example of the optical sensing system 100 is described.

A subject is not limited to a raw materials heap in a raw material yard. A subject may be any object as long as the object is an object to be a subject (i.e. a subject of generation of a three-dimensional model) of acquisition of point cloud data. For example, a subject may be an aircraft parked at an airport. In this case, the airport is a subject space.

Further, signal processing executed by the signal processing unit 34 may use an electric signal being relevant to a second optical signal, and is not limited to the above specific example.

For example, the signal processing unit 34 may not only execute measurement of the distance D and generation of point cloud data, but also generate a three-dimensional model of a subject by use of the generated point cloud data. That is to say, generation of a three-dimensional model may be executed by the signal processing unit 34 instead of being executed by the host system 200. In this case, the signal processing unit 34 includes a three-dimensional model generation unit (not illustrated) in addition to the distance measurement unit 41 and the point cloud data generation unit 42. Result information transmitted by the communication unit 35 includes a three-dimensional model generated by the 3D model generation unit. The host system 200 estimates a volume of a subject, or detects occurrence of an abnormality in the subject, by use of the generated three-dimensional model.

Alternatively, for example, the signal processing unit 34 may execute only measurement of the distance D, between measurement of the distance D and generation of point cloud data. That is to say, the signal processing unit 34 may include only the distance measurement unit 41 among the distance measurement unit 41 and the point cloud data generation unit 42. In this case, result information to be transmitted by the communication unit 35 includes distance information indicating the measured distance D, and associated emission position information and emission direction information. The host system 200 generates point cloud data by executing point cloud synthesis by use of the pieces of information. The host system 200 generates a three-dimensional model of a subject by use of the generated point cloud data.

Further, the signal processing device 2 may not include the signal processing unit 34. In this case, the communication unit 35 transmits, to the host system 200, information indicating an electric signal output by the optical signal acquisition unit 32, instead of transmitting result information to the host system 200. Further, the communication unit 35 transmits, to the host system 200, emission position information and emission direction information being relevant to each of the individual second optical signals. The host system 200 executes measurement of the distance D and generation of point cloud data by use of the pieces of information. The host system 200 generates a three-dimensional model of a subject by use of the generated point cloud data.

Further, at least the one scanner device 1 among the plurality of scanner devices 1 may be of a mobile type. The mobile scanner device 1 is movable independently of the another scanner device 1. The mobile scanner device 1 emits a laser beam for sensing toward a subject from each of a plurality of mutually different positions by moving.

Further, generation and display of a point cloud image may be executed by the signal processing device 2 instead of being executed by the host system 200. Further, generation and display of a three-dimensional model image may be executed by the signal processing device 2 instead of being executed by the host system 200. That is to say, the signal processing device 2 generates a point cloud image or a three-dimensional model image, and displays the generated image on a non-illustrated display unit (e.g. display). A person (e.g. a user of the optical sensing system 100) can easily visually recognize a shape of a subject by displaying the point cloud image or the three-dimensional model image.

Further, the relevance relationship between the plurality of optical fiber cables 3 and the plurality of scanner devices 1 is not limited to one-to-one. For example, the one optical fiber cable 3 among the plurality of optical fiber cables 3 may be constituted of a branch cable, and the one optical fiber cable 3 may be connected to the two or more scanner devices 1 among the plurality of scanner devices 1.

Next, an effect of the optical sensing system 100 is described.

As described above, the optical sensing system 100 includes the plurality of scanner devices 1 installed at mutually different sites, and the signal processing device 2 connected to the plurality of scanner devices 1 by use of the plurality of optical fiber cables 3. A plurality of scanner devices 1 emit laser beams toward a subject, and receive reflected light reflected by the subject. The signal processing device 2 outputs, to the plurality of scanner devices 1 via the plurality of optical fiber cables 3, a first optical signal being relevant to laser beams emitted by the plurality of scanner devices 1, and acquires, from the plurality of scanner devices 1 via the plurality of optical fiber cables 3, a second optical signal being relevant to the reflected light received by the plurality of scanner devices 1. Thereby, the following effect is exerted.

Firstly, the following advantageous effect is exerted compared to a LiDAR system described in PTL 1, by use of the plurality of scanner devices 1 installed at mutually different sites.

That is to say, by using the plurality of scanner devices 1 installed at mutually different sites, the scanner devices 1 can be arranged around the subject (see FIG. 11). Thereby, the laser beam for sensing is applied to the same subject from a plurality of mutually different positions. In other words, the laser beam for sensing is applied to the same subject from a plurality of mutually different directions. As a result, occurrence of a part to which a laser beam for sensing is not applied can be suppressed in the subject. Thereby, when a three-dimensional model of the subject is generated, occurrence of a missing part resulting from a failure of application of a laser beam for sensing can be suppressed.

More specifically, the plurality of scanner devices 1 can be disposed in such a way as to surround a subject, by using the plurality of scanner devices 1 installed at mutually different sites (see FIG. 11). Thereby, a laser beam for sensing is applied to the overall subject. As a result, occurrence of a missing part in the three-dimensional model can be avoided. In this way, in the optical sensing system 100 in which the signal processing device 2 and the individual scanner devices 1 are connected by use of the optical fiber cable 3, the overall shape of the subject can be recognizable.

Secondly, the following advantageous effect is exerted compared to the optical sensing system 100′ for comparison, by use of a type in which the signal processing device 2 and the individual scanner devices 1 are connected by use of the optical fiber cable 3.

That is to say, in suppressing occurrence of the missing part as described above, the number of the signal processing devices 2 in the optical sensing system 100 can be reduced compared to the number of the signal processing units 2′ in the optical sensing system 100′ (see FIGS. 11 and 12). Thereby, a configuration of the optical sensing system 100 can be simplified compared to a configuration of the optical sensing system 100′. Further, the signal processing device 2 is usually expensive compared to each of the individual scanner devices 1. That is to say, each of the individual signal processing units 2′ is expensive compared to each of the individual scanner units 1′. Thus, by reducing the number of the signal processing devices 2 compared to the number of the signal processing units 2′, the optical sensing system 100 can be inexpensively achieved than the optical sensing system 100″.

Further, distance attenuation of a signal in an optical fiber cable is usually less compared to distance attenuation of a signal in a wired electric communication line (e.g. a LAN cable). Thus, the number of the optical repeaters 5 in the optical sensing system 100 can be reduced compared to the number of the repeaters 5′ in the optical sensing system 100′ (see FIGS. 11 and 12). Especially, when an area of a subject space is large, and a subject is disposed over a wide range, the number of the optical repeaters 5 can be greatly reduced compared to the number of the repeaters 5. Thereby, the configuration of the optical sensing system 100 can be further simplified compared to the configuration of the optical sensing system 100″.

Next, another effect of the optical sensing system 100 is described.

The plurality of scanner devices 1 are disposed around a subject. Thereby, as described above, a laser beam for sensing is applied to the same subject from a plurality of mutually different positions. In other words, a laser beam for sensing is applied to the same subject from a plurality of mutually different directions. As a result, occurrence of a part to which a laser beam for sensing is not applied can be suppressed in the subject.

Further, the plurality of scanner devices 1 emit laser beams toward the same subject from mutually different directions. Thereby, as described above, occurrence of a region to which a laser beam for sensing is not applied can be suppressed in the subject. As a result, when a three-dimensional model of the subject is generated, occurrence of a missing part resulting from a failure of application of a laser beam for sensing can be suppressed.

Further, at least the one scanner device 1 among the plurality of scanner devices 1 is movable independently of the another scanner device 1 among the plurality of scanner devices 1. The mobile scanner device 1 can emit a laser beam for sensing toward the same subject from each of a plurality of mutually different positions by moving. Thus, by using the mobile scanner device 1, the number of the required scanner devices 1 can be reduced in applying a laser beam for sensing to the overall subject. That is to say, the number of the scanner devices 1 included in the optical sensing system 100 can be reduced. As a result, a configuration of the optical sensing system 100 can be further simplified.

Further, the optical sensing system 100 includes the optical repeater 5 provided in at least the one optical fiber cable 3 among the plurality of optical fiber cables 3. Thereby, the optical sensing system 100 can be achieved even when a laying length of the one optical fiber cable 3 is long.

Further, the signal processing device 2 includes an optical switch 53 for switching an output destination of a first optical signal and an acquisition source of a second optical signal. Thereby, occurrence of mixing of an optical signal between the scanner devices 1 can be avoided in the signal processing device 2.

Further, a subject is a raw materials heap in a raw material yard. The plurality of scanner devices 1 are installed in a raw material yard. Thereby, for example, the optical sensing system 100 can be used for estimation of a volume of a raw materials heap or detection of occurrence of an abnormality in a raw materials heap.

Further, a subject is an aircraft parked at an airport. The plurality of scanner devices 1 are installed at the airport. Thereby, for example, the optical sensing system 100 can be used for detection of occurrence of an abnormality in a parked aircraft.

While the invention has been particularly shown and described with reference to exemplary example embodiments thereof, the invention is not limited to the example embodiments. It is understood by those of ordinary skill in the art that various changes in form and details may be made therein without departing from the spirit and scope of the present invention as defined by the claims.

Some or all of the above-described example embodiments can also be described as, but are not limited to, the following supplementary notes.

### SUPPLEMENTARY NOTE

### Supplementary Note 1

An optical sensing system including:
a plurality of scanner devices that are installed at mutually different sites; and
a signal processing device being connected to the plurality of scanner devices by use of a plurality of optical fiber cables, wherein
the plurality of scanner devices emit laser beams toward a subject, and receive reflected light reflected by the subject, and
the signal processing device outputs, to the plurality of scanner devices via the plurality of optical fiber cables, a first optical signal being relevant to the laser beams to be emitted by the plurality of scanner devices, and acquires, from the plurality of scanner devices via the plurality of optical fiber cables, a second optical signal being relevant to the reflected light received by the plurality of scanner devices.

### Supplementary Note 2

The optical sensing system according to supplementary note 1, wherein
the plurality of scanner devices are disposed around the subject.

### Supplementary Note 3

The optical sensing system according to supplementary note 1 or 2, wherein
the plurality of scanner devices emit the laser beams toward the same subject from mutually different directions.

### Supplementary Note 4

The optical sensing system according to any one of supplementary notes 1 to 3, wherein
at least one scanner device among the plurality of scanner devices is movable independently of another scanner device among the plurality of scanner devices.

### Supplementary Note 5

The optical sensing system according to any one of supplementary notes 1 to 4, further including
an optical repeater provided in at least one optical fiber cable among the plurality of optical fiber cables.

### Supplementary Note 6

The optical sensing system according to any one of supplementary notes 1 to 5, wherein
the signal processing device includes an optical switch for switching an output destination of the first optical signal and an acquisition source of the second optical signal.

### Supplementary Note 7

The optical sensing system according to any one of supplementary notes 1 to 6, wherein
the subject is a raw materials heap in a raw material yard, and the plurality of scanner devices are installed in the raw material yard.

### Supplementary Note 8

The optical sensing system according to any one of supplementary notes 1 to 6, wherein
the subject is an aircraft parked at an airport, and
the plurality of scanner devices are installed at the airport.

### Supplementary Note 9

An optical sensing method including:
by a plurality of scanner devices that are installed at mutually different sites, emitting laser beams toward a subject, and receiving reflected light reflected by the subject; and,
by a signal processing device being connected to the plurality of scanner devices by use of a plurality of optical fiber cables, outputting, to the plurality of scanner devices via the plurality of optical fiber cables, a first optical signal being relevant to the laser beams to be emitted by the plurality of scanner devices, and acquiring, from the plurality of scanner devices via the plurality of optical fiber cables, a second optical signal being relevant to the reflected light received by the plurality of scanner devices.

### Supplementary Note 10

The optical sensing method according to supplementary note 9, wherein
the plurality of scanner devices are disposed around the subject.

### Supplementary Note 11

The optical sensing method according to supplementary note 9 or 10, wherein
the plurality of scanner devices emit the laser beams toward the same subject from mutually different directions.

### Supplementary Note 12

The optical sensing method according to any one of supplementary notes 9 to 11, wherein
at least one scanner device among the plurality of scanner devices moves independently of another scanner device among the plurality of scanner devices.

### Supplementary Note 13

The optical sensing method according to any one of supplementary notes 9 to 12, wherein
an optical repeater is provided in at least one optical fiber cable among the plurality of optical fiber cables.

### Supplementary Note 14

The optical sensing method according to any one of supplementary notes 9 to 13, wherein
an optical switch of the signal processing device switches an output destination of the first optical signal and an acquisition source of the second optical signal.

### Supplementary Note 15

The optical sensing method according to any one of supplementary notes 9 to 14, wherein
the subject is a raw materials heap in a raw material yard, and the plurality of scanner devices are installed in the raw material yard.

### Supplementary Note 16

The optical sensing method according to any one of supplementary notes 9 to 14, wherein
the subject is an aircraft parked at an airport, and
the plurality of scanner devices are installed at the airport.

### REFERENCE SIGNS LIST

1 Scanner device
2 Signal processing device
3 Optical fiber cable
4 Electric communication line
5 Optical repeater
11 Light emission unit
12 Light reception unit
21 Optical system
31 Optical signal output unit
32 Optical signal acquisition unit
33 Optical switch unit
34 Signal processing unit
35 Communication unit
41 Distance measurement unit
42 Point cloud data generation unit
51 Optical transmitter
52 Optical receiver
53 Optical switch
54 Transmitter
55 Receiver
56 Processor
57 Memory
58 Processing circuit
100 Optical sensing system
200 Host system

What is claimed is:

1. An optical sensing system comprising:
a plurality of scanner devices that are installed at mutually different sites; and
a signal processing device being connected to the plurality of scanner devices by use of a plurality of optical fiber cables, wherein
the plurality of scanner devices emit laser beams toward a subject, and receive reflected light reflected by the subject, and
the signal processing device outputs, to the plurality of scanner devices via the plurality of optical fiber cables, a first optical signal being relevant to the laser beam to be emitted by each of the plurality of scanner devices, and acquires, from the plurality of scanner devices via the plurality of optical fiber cables, a second optical signal being relevant to the reflected light received by each of the plurality of scanner devices.

2. The optical sensing system according to claim 1, wherein
the plurality of scanner devices are disposed around the subject.

3. The optical sensing system according to claim 1, wherein
the plurality of scanner devices emit the laser beams toward the same subject from mutually different directions.

4. The optical sensing system according to claim 1, wherein
at least one scanner device among the plurality of scanner devices is movable independently of another scanner device among the plurality of scanner devices.

5. The optical sensing system according to claim 1, further comprising
an optical repeater provided in at least one optical fiber cable among the plurality of optical fiber cables.

6. The optical sensing system according to claim 1, wherein
the signal processing device includes an optical switch for switching an output destination of the first optical signal and an acquisition source of the second optical signal.

7. The optical sensing system according to claim 1, wherein
the subject is a raw materials heap in a raw material yard, and
the plurality of scanner devices are installed in the raw material yard.

8. The optical sensing system according to claim 1, wherein
the subject is an aircraft parked at an airport, and
the plurality of scanner devices are installed at the airport.

9. An optical sensing method comprising:
by a plurality of scanner devices that are installed at mutually different sites, emitting laser beams toward a subject, and receiving reflected light reflected by the subject; and,
by a signal processing device being connected to the plurality of scanner devices by use of a plurality of optical fiber cables, outputting, to the plurality of scanner devices via the plurality of optical fiber cables, a first optical signal being relevant to the laser beam to be emitted by each of the plurality of scanner devices, and acquiring, from the plurality of scanner devices via the plurality of optical fiber cables, a second optical signal being relevant to the reflected light received by each of the plurality of scanner devices.

10. The optical sensing method according to claim 9, wherein
the plurality of scanner devices are disposed around the subject.

11. The optical sensing method according to claim 9, wherein
the plurality of scanner devices emit the laser beam toward the same subject from mutually different directions.

12. The optical sensing method according to claim 9, wherein
at least one scanner device among the plurality of scanner devices moves independently of another scanner device among the plurality of scanner devices.

13. The optical sensing method according to claim 9, wherein
an optical repeater is provided in at least one optical fiber cable among the plurality of optical fiber cables.

14. The optical sensing method according to claim 9, wherein
an optical switch of the signal processing device switches an output destination of the first optical signal and an acquisition source of the second optical signal.

15. The optical sensing method according to claim 9, wherein
the subject is a raw materials heap in a raw material yard, and
the plurality of scanner devices are installed in the raw material yard.

16. The optical sensing method according to claim 9, wherein
the subject is an aircraft parked at an airport, and
the plurality of scanner devices are installed at the airport.
